(19) United States
(12) Patent Application Publication
(10) Pub. No.: US 2004/0095569 A1
(43) Pub. Date: May 20, 2004

(54) USE OF LINEAR SCATTERING LOSSES TO CHARACTERIZE AMPLIFIED FIBER SPANS

(76) Inventor: Clarence Kwok-Yan Kan, Bridgewater, NJ (US)

Correspondence Address: HAYES SOLOWAY PC, 130 W. Cushing Street, Tucson, AZ, 85701, US

(21) Appl. No.: 10/300,156

(22) Filed: Nov. 20, 2002

(51) Int. Cl. G01N 21/00

(52) U.S. Cl. 356/73.1

(57) ABSTRACT

A method is presented for calculating the Rayleigh backscattered signal (RBS) for an inhomogeneous fiber span amplified by a counter-propagating pump source, the fiber span being a concatenation of sections of different types of fiber. The method may be used to determine the Raman gain coefficients of each fiber section within the inhomogeneous fiber span. In addition, when the Raman gain coefficients for the fiber types are known, the method may be used to determine the fiber type of a section, if unknown.

### FIELD OF THE INVENTION

The invention resides in the field of optical telecommunications networks, and is directed in particular to a method for characterizing amplified fiber spans.

### BACKGROUND OF THE INVENTION

Modern optical WDM (wavelength division multiplexing) networks are made of switching/OADM nodes connected by a line system. The nodes are concerned with switching and/or passing through the channels from an input WDM (wavelength division multiplexing) signal into one or more output WDM signal(s), and/or with adding/dropping the on-ramp/off-ramp user signals into/from the respective output or input WDM signal. The line system includes the optical components and the fiber between two successive switches, and is concerned with conditioning (line amplification, power control, dispersion control, etc.) the WDM signals to achieve long-haul transmission.

The channel reach, or the distance traveled by an optical channel between a source node and a destination node is limited by the combined effect of attenuation (fiber loss) and distortion experienced by the signal carried by the respective optical channel. In the transmission portion of the network, the optical loss is caused by the fiber, dispersion compensators, line VOAs and gain equalizers provided for conditioning the WDM signal. In the node portion, the loss is caused by the switches, OADMs, channel VOAs and equalizers.

A solution to compensate for this loss is to place optical amplifiers at selected points along the fibers connecting the network nodes. An optical amplifier amplifies all channels within a transmission band without performing optical-to-electrical-to-optical (OEO) conversion. Most popular optical amplifier is the fiber amplifier that uses an optical fiber doped with a rare earth element such as erbium, called EDFA (Erbium doped fiber amplifier). State-of-the-art optical fiber systems that operate at 2.5 Gb/s or 10 Gb/s and at a nominal system wavelength of 1550 nm, use EDFAs spaced up to 100 km apart. Multi-channel WDM systems increase this capacity. Unfortunately, the EDFA gain is wavelength dependent so that the channels in the WDM signal are amplified differently, depending on the wavelength of the channel on which they travel. In other words, the EDFA introduces a gain tilt. It is known to correct gain tilt using gain flattening filters such as dynamic gain equalizers DGE, and lately tunable DGEs. Also, the EDFA gain becomes non-linear at high input powers due to SBS (spontaneous Brillouin scattering).

In recent years, as optical technology evolved, there has been an increased interest in Raman amplifiers and they are now starting to find applications in optical WDM networks. Raman amplification is based on the Stimulated Raman Scattering (SRS) effect, namely the migration of power from lower wavelength channels to higher wavelength channels. Thus, by pumping the fiber using a laser of a certain power and wavelength, the signal passing through that fiber is amplified. In addition to compensating the attenuation in the fiber, use of SRS allows extension of transmission band to wavelengths outside the gain band of Erbium, gives a very broad gain bandwidth and distributed amplification. As a result of using hybrid EDFA—Raman optical amplifiers and the above corrective techniques, distances of over 3,000 km were obtained lately experimentally, and research for increasing this distance continues.

Ideally, the fiber gain should be the independent of the number of channels in the WDM signal and of the channels wavelengths, and should vary linearly with the input power. The Raman gain coefficient, or simply the Raman gain spectrum in optical fiber depends on many factors, such as the Raman pump wavelength(s), the number and wavelengths of the channels in the WDM signal, the fiber type, etc. SRS redistributes the optical power between the channels present on the respective fiber span, by transferring power from the shorter wavelengths to the longer wavelength channels. The strength of this interaction is determined by the Raman gain coefficient corresponding to the wavelength difference between the channels. Since the data intensity-modulate the optical channels, SRS gives rise to inter-channel cross-talk. Assessing the impairment induced by the SRS requires knowledge of the spectral dependence of the Raman gain coefficient.

Typically, a Raman pump operates at 13 THz below the signal wavelength, and injects light in a direction opposite to the traffic flow; pumping in the forward direction is also possible. The frequency (or wavelength) difference between the pump and the frequency (or wavelength) of maximum gain is often referred to as the ‘Stokes shift’, and the amplified signal is referred to as the Stokes wave. Use of a pump that is detuned from the signals by about one Stokes shift (½ Stoke shift to 3/2 shift) is referred to as first-order Stokes pumping. Multiple-order Raman amplifier systems (systems that use more pump wavelengths) were designed with the goal to reduce the noise, reach longer fiber spans and reduce nonlinearities. As there is a relationship between the wavelengths amplified by the SRS and the pump wavelength (Raman scattering phenomena produces gain at wavelengths higher than the pump wavelength), selection of the Raman pumps wavelengths depends on the transmission band used for traffic.

The spectral intensity profile of the Raman gain is also dependent on the power and wavelength of the channels in the WDM signal. This dependence is particularly relevant in agile networks, where the number and wavelength of the channels change in time, while the Raman gain must be maintained to a target value.

In addition, evolution of optical networking and the inherent evolution of manufacturing techniques for fiber over the last decades resulted in a very inhomogeneous deployed fiber plant. Thus, in most cases, the type and characteristics of the fiber buried in the early days of optical networking is not known, which poses important challenges to network providers and operators. Even more challenging is that a fiber link may be made of sections of different fiber types, of unknown type. Especially in these occasions, it is very difficult to determine the operating parameters needed for proper design of the optical amplifiers to be connected along such an inhomogeneous fiber link. Still further, the glass that makes up the fiber is doped with chemicals; the doping is not always uniform across the cross-section of the fiber for a certain fiber type, which additionally alter the Raman spectrum.

It is important, even critical to know the spectral dependence of the Raman gain coefficient for evaluating transmission performance of the respective span and for designing Raman amplifiers with a spectrum that take advantage and account for the respective fiber characteristics.

Several techniques are used to determine the Raman gain coefficient in optical fibers. For example, it is known to measure the output power of a probe light, which was amplified using a Raman pump of a certain power. The ration of the output over the input power for the known pump power provides the gain coefficient based on the assumption of exponential growth of the probe light. Measuring the spectrum requires effecting measurements for a large number of probe wavelengths to cover the entire transmission band.

It is also known to compare the power level of the Raman scattered light from a test fiber with a reference fiber. However, this allows measurements at a single wavelength, or requires a tunable reference fiber.

The article “Measurement of Raman Gain Distribution in Optical Fibers (Kunihiro Toge et al.) published in IEEE Photonic Technology Letters, Vol. 14, No. 7, July 2002 proposes a technique for measuring the Raman gain coefficients by measuring the output signal as a function of time. However, being based on time measurements, this method is rather difficult to implement in live network as it requires a rather complex test setting. Thus, in order for this technique to work, it requires an accurate knowledge of the pump pulse width. In addition, a zero time reference, provided for the CW signal measurement, must be synchronized with the launching of the pump pulse. Still further, this method requires that the input CW signal be polarization scrambled, and assumes knowledge of pump loss coefficient for each fiber in the span.

Canadian Patent Application 2,378,069 “Method and System for Automatic Optical Fiber Identification” (Reepschlager), published on Oct. 4, 2002 describes equipping a line with a plurality of OSAs (optical spectrum analyzers) to measure the gain profile of one or more optical amplifiers along the respective line. The profiles are then manipulated in order to obtain a score for the fiber span, which is compared to known scores for various fiber types. The profile may represent either the respective fiber loss or Raman gain.

There is a need to provide a method for determining the Raman gain coefficients for an amplified inhomogeneous fiber span, for accurately characterizing the performance of a fiber span.

### SUMMARY OF THE INVENTION

It is an object of the invention to provide a method of characterizing amplified fiber spans, which is particularly useful for networks build of inhomogeneous fiber spans.

Accordingly, the invention provides a method for determining the Raman gain coefficient for a fiber section of an inhomogeneous fiber span provided with a Raman pump unit, comprising: effecting Rayleigh backscattered signal RBS measurements at a location on a fiber section specified by a distance “/” from a signal source; determining an on/off Raman gain based on the RBS measurements; and determining the Raman gain coefficient of the fiber section at the respective specified location.

Advantageously, the technique according to the invention is simple and allows determining the Raman gain coefficients for the fiber sections of an inhomogeneous fiber span. Conversely, when the Raman gain coefficients are known, the technique according to the invention allows determining the unknown fiber type.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 shows an inhomogeneous fiber span amplified by a counter-propagating pump source; and

FIG. 2 illustrates how Rayleigh backscattered signal is calculated for the inhomogeneous fiber span of FIG. 1.

### DETAILED DESCRIPTION OF THE PREFERRED EMBODIMENTS

The present invention is based on quantifying the Rayleigh scattering for a fiber span amplified with a counter-propagating pump source (Raman amplified fiber).

Rayleigh backscattering (RBS) produces elastically scattered signals with a wavelength distribution substantially the same with that of the injected signal. This linear (wavelength independent) scattering is the dominant intrinsic loss mechanism in the low absorption window between the ultraviolet and infrared absorption zones of the transmission spectrum. It results from inhomogeneities of a random nature occurring on a small scale compared with the wavelength of the light that travels in the fiber, and the scattering is almost in all directions. These inhomogeneities manifest themselves as refractive index fluctuations and arise from density and compositional variations, which are frozen into the glass lattice during manufacture.

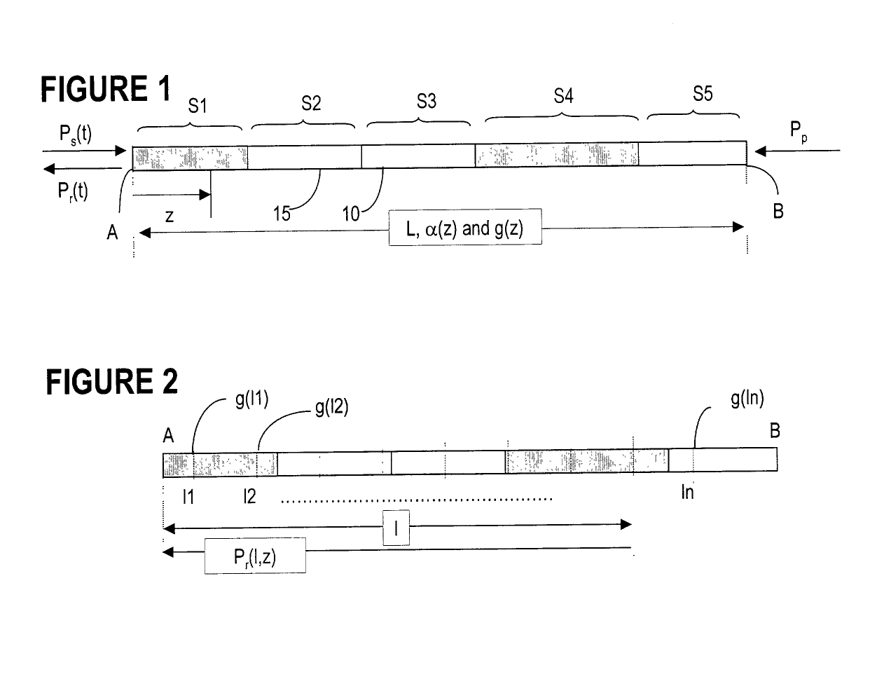

FIG. 1 illustrates an inhomogeneous fiber span, where a signal Pₛ(t) (i.e. the user signal) traveling along this span is being amplified by a counter-propagating pump source Pp. The fiber span has a length A-B denoted with L, and comprises a plurality of sections made of different fiber types. This inhomogeneity results in a Rayleigh backscattered signal RBS whose power is denoted with Pᵣ(t).

If we denote with α(z) the fiber loss coefficient, in a small signal regime, the propagation of the CW pump is described by:

$$\frac{ⅆ {P}_{p}}{ⅆ z} = + {α}_{p} ( z ) {P}_{p} \qquad EQ 1$$

where variable z is the distance from the signal source to the point of interest, and p identifies the pump signal. The fiber loss coefficient α(z) varies with z since the fiber is, as discussed and shown in FIG. 1, inhomogeneous.

The general solution of EQ1 is:

$${P}_{p} = {P}_{p}^{0} exp ( - {\int }_{z}^{L} {α}_{p} ( {z}^{′} ) ⅆ {z}^{′} \qquad EQ 2$$

were Pₚ⁰ is the pump power at z=L.

By assuming a negligible group velocity dispersion and applying the variable transformation (z,t)→(z,t−z/ν_{g}), the propagation of the signal in the small signal regime is described by:

$$\frac{ⅆ {P}_{s}}{ⅆ z} = - α ( z ) {P}_{s} + g ( z ) {P}_{s} {P}_{p} ( z ) \qquad EQ 3$$

where g(z) the inhomogeneous Raman gain coefficient, which varies with the distance, and s identifies the test signal.

The general solution for EQ3 is:

Pₛ(z)=Pₛ⁰ exp(∫₀^{z}(−α(z′)+g(z′)Pₚ(z′))dz′ EQ4

The Rayleigh backscattering power is described by:

$$\frac{ⅆ {P}_{r}}{ⅆ z} = + α ( z ) {P}_{r} + g ( z ) {P}_{r} {P}_{p} ( z ) \qquad EQ 5$$

The general solution for the RBS power at z=l, shown in FIG. 2 and detected in point A (at z=0) is:

$${P}_{r} ( l , z = 0 ) = Kr ( l ) {P}_{s} ( l ) exp ( {\int }_{0}^{l} ( - {α}_{s} ( {z}^{′} ) + g ( {z}^{′} ) {P}_{p} ( {z}^{′} ) ) ⅆ {z}^{′} ) \qquad EQ 6$$

where r(l) is the Rayleigh coefficient at z=l and K is a constant.

If we substitute Pₛ(z) from EQ4 above,

$${P}_{r} ( l , z = 0 ) = Kr ( l ) {P}_{s}^{0} exp ( 2 {\int }_{0}^{l} ( - {α}_{s} ( {z}^{′} ) + g ( {z}^{′} ) {P}_{p} ( {z}^{′} ) ) ⅆ {z}^{′} ) \qquad EQ 7$$

Using a similar analysis as in “Fiber Optic Test and Measurement” Prentice Hall, 1^{st} Edition, 1998, p.450, the backscattered light detected at z=0 and t=2 l/ν_{g}, for a rectangular pulse signal with a spatial width W is:

$${P}_{r}^{W} ( l ) = {\int }_{0}^{W / 2} Kr ( l - Δ z ) {P}_{s}^{0} exp ( 2 {\int }_{0}^{l - Δ z} ( - {α}_{s} ( {z}^{′} ) + g ( {z}^{′} ) {P}_{p} ( {z}^{′} ) ) ⅆ {z}^{′} ) ⅆ Δ z \qquad EQ 8$$

By assuming a short pulse width and that the fiber characteristics are constant within a distance equal to the pulse width, we obtain:

$${P}_{r}^{W} ( l ) = K \frac{W}{2} r ( l ) {P}_{s}^{0} exp ( 2 {\int }_{0}^{l} ( - {α}_{s} ( {z}^{′} ) + g ( {z}^{′} ) {P}_{p} ( {z}^{′} ) ) ⅆ {z}^{′} ) \qquad EQ 9$$

We define now the on-off gain G_{on/off} as the ratio between the Raman gain with the pump operating at nominal value and the Raman gain with the pump turned off. Namely:

$${G}_{on / off} = \frac{{P}_{r}^{W}}{{P}_{r}^{W} at {P}_{p}^{0}} \qquad EQ 10$$

Then:

$$\frac{ⅆ ln {G}_{on / off}}{ⅆ z} = 2 g ( z ) {P}_{p} ( z ) \qquad EQ 11$$

The Raman coefficient g(z) can be determined now as follows:

$$g ( z ) = \frac{1}{2 {P}_{p}^{0} {ⅇ}^{{\int }_{z}^{L} {α}_{p} ( {z}^{′} ) ⅆ {z}^{′}}} \frac{ⅆ ln {G}_{o n / off}}{ⅆ z} \qquad EQ 12$$

In practice, the Raman gain coefficient g(z) can be determined following the steps listed below. The measurements are repeated at different locations along the fiber, shown as in FIG. 2, for determining the Raman gain coefficient g(l1), g(l2) . . . g(ln), etc. in these points.

1. Measure the OTDR trace at the pump wavelength, to determine the pump loss, when the Raman pump is ‘off’.

2. Measure OTDR trace at the signal wavelength when the pump is ‘off’.

3. Measure OTDR trace when pump is ‘on’ at the signal wavelength.

4. Calculate on/off gain according to EQ10 by dividing the OTDR trace determined at (2) by the OTDR trace determined at (3), in linear units.

5. Use EQ12 to determine the Raman gain coefficient.

Alternatively, when the Raman gain coefficients of different fiber types are known, the technique can be used to determine the type of fiber used for the respective section of the inhomogeneous fiber span.

I claim:

1. A method for determining the Raman gain coefficient for a fiber section of an inhomogeneous fiber span provided with a Raman pump unit, comprising:
obtaining loss measurements at a location on said fiber section specified by a distance “/” from a signal source;
determining an on/off Raman gain G_{on/off} based on said loss measurements; and
determining the Raman gain coefficient of said fiber section at said specified location.

2. A method as claimed 1, wherein said loss measurements comprise a Rayleigh backscattered signal RBS.

3. A method as claimed in claim 2, wherein said step of measuring comprises:
with said Raman pump unit “off”,
measuring the power of the RBS at a nominal pump wavelength, to determine a pump loss value Pᵣ⁰;
measuring the RBS power at a test signal wavelength Pᵣ^{W}; and
with said Raman pump unit “on” at said nominal pump wavelength,
measuring the RBS power at said signal wavelength Pᵣ^{W} |Pₚ⁰=0.

4. A method as claimed in claim 3, wherein said step of determining an on/off Raman gain G_{on/off} comprises dividing Pᵣ^{W} to Pᵣ^{W} |Pₚ⁰=0.

5. A method as claimed in claim 1, wherein said determining the Raman gain coefficient comprises calculating said gain coefficient “g” using
$$g ( z ) = \frac{1}{2 {P}_{p}^{0} {ⅇ}^{{\int }_{z}^{L} {α}_{p} ( {z}^{′} ) ⅆ {z}^{′}}} \frac{ⅆ ln {G}_{o n / off}}{ⅆ z} \qquad EQ 12$$

6. A method as claimed in claim 1, further comprising using fiber-Raman gain coefficient tables for determining the fiber type of said fiber section based on said Raman gain coefficient.
